(19) United States
(12) Patent Application Publication
(10) Pub. No.: US 2010/0157723 A1
(43) Pub. Date: Jun. 24, 2010

(54) A LIQUID STORAGE DEVICE

(76) Inventor: ALEJANDRO JOSE DE LA VEGA, Paddington (AU)

Correspondence Address: ALEJANDRO DE LA VEGA, 67 GOODHOPE STREET, PADDINGTON, 2021, omitted

(21) Appl. No.: 12/600,490

(22) PCT Filed: May 19, 2008
(86) PCT No.: PCT/AU08/00688

§ 371 Date: Nov. 17, 2009

(30) Foreign Application Priority Data
May 18, 2007 (AU) 2007902665

(51) Int. Cl. B01F 15/04; B67D 7/78; B65D 47/20; B65D 25/40

(52) U.S. Cl. 366/162.2; 222/145.5; 222/548; 222/566

(57) ABSTRACT

A container (10) including first and second reservoirs (11, 14) for containing products to be mixed. The first and second reservoirs (11, 14) each have an opening, with the opening of the first reservoir (11) being closed by a threaded lid (12). The second reservoir (14) has a storage position and a discharge position for discharging product contained in the second reservoir (14) into the first reservoir (11) for mixing with the product of the first reservoir (11). Displacement of the second reservoir (14) from the storage position to the discharge position requires rotation of the lid (12) in a direction to open the opening of the first reservoir (11) whereby that rotation facilitates release of the second reservoir (14) from the storage position.

### FIELD OF THE INVENTION

The present invention relates generally to a liquid storage device, more particularly to a liquid storage device which permits a product or a substance to be selectively added to a liquid and to a method of selectively adding such a product or substance to a liquid.

The invention has been principally developed in relation to bottles to allow the selective addition of powdered supplements to water and it will be convenient to the invention in reference to that application. However, it is to be appreciated that the invention is not limited to that particular application and for example, the supplement could be a liquid, gel tablet or other supplement form.

### BACKGROUND OF THE INVENTION

The consumption of bottled water is very popular. Further, the consumption of bottled water, and other liquids premixed with vitamins or other substances is also very popular.

A disadvantage of some ‘premixed’ drinks is that the efficacy of the vitamins, or other substances, can be compromised as a result of their storage in a suspended state in the water.

One approach to address this disadvantage is to provide the vitamins or other substances separately, so that they can be added to the water or other liquid just prior to consumption, for example after exercising. A disadvantage of this approach is that the user is required to add the vitamins or other substance to the water or other liquid, usually from a separate container and this can be inconvenient and/or time consuming, particularly if the mixing is required during exercise, or in locations where mixing is difficult to conduct.

In applicant's co-pending International PCT Application PCT/AU2007/000699, published under WO 2007/134392, a liquid storage device is disclosed in which a liquid reservoir and a substance reservoir are provided. In that device, typically the substance reservoir is ruptured to release the substance of that reservoir into the liquid reservoir.

The present applicant has developed a new liquid storage device that includes a liquid reservoir and a substance reservoir. In this new device, rupturing of the substance reservoir is not required. Moreover, in the new liquid storage device, the arrangement employed to release the substance of the substance reservoir into the liquid reservoir is simple and intuitive.

### SUMMARY OF THE INVENTION

According to a first aspect of the present invention there is provided a container including:
first and second reservoirs for containing products to be mixed, the first and second reservoirs each having an opening through which release of product contained in the respective reservoirs can egress, the opening of the first reservoir being closed by a threaded lid in a closed condition of the container,
the second reservoir having:
i—a storage position in which a product contained in the second reservoir is maintained separate from a product contained in the first reservoir, and
ii—a discharge position displaced from the storage position in which a product contained in the second reservoir is dischargeable through the second reservoir opening into the first reservoir for mixing with the product contained in the first reservoir,
wherein displacement of the second reservoir from the storage position to the discharge position requires rotation of the lid in a direction to open the opening of the first reservoir, that rotation facilitating release of the second reservoir from the storage position.

A principle advantage of the present invention, is that there is no requirement for any part of the container to be ruptured in order to discharge the product contained in the second reservoir into the first reservoir for mixing. In addition, the act of releasing and displacing second reservoir from the storage position to the discharge position employs the simple operation of rotation of the container lid. Thus, a user of the container is not required to operate the container in a manner which is foreign, but rather, the user would be familiar with the manner in which a lid is removed from such a container, usually a drinking container, and therefore the user would require little education or instruction in order to readily appreciate the manner in which mixing of the products contained in the first and second reservoirs is to be achieved.

The container can be arranged so that the amount of rotation of the lid which is necessary to release the second reservoir from the storage position so that the second reservoir is displaced from that position, is less than the amount of rotation required to open the opening of the first reservoir. Thus, release of the second reservoir from the storage position does not require full removal of the lid from the first reservoir, but rather, can require a lesser amount of rotation. In some arrangements, the amount of rotation of the lid required to release the second reservoir from the storage position, is less than half a turn of the lid. Advantageously, this allows a user of the container to mix the products of the first and second reservoirs with only a minor rotation of the lid and without having to fully open the opening of the first reservoir, which could present the possibility of spillage from the container.

In some arrangements, it is preferred that upon release of the second reservoir from the storage position, the second reservoir is displaced from the storage position to the discharge position by gravity or under it's own weight. That is, the second reservoir requires no additional displacement influence other than gravity in order to be displaced to the discharge position. The container must therefore be properly orientated to allow the second reservoir to be displaced in this manner, but it is expected that for most containers, the proper orientation will automatically be adopted as being the usual orientation in which such a container is held.

In the above arrangement in which the rotation of the lid which is required to release the second reservoir from the storage position is less than that required to open the opening of the first reservoir, the lid can be returned to a position to close the opening of the first reservoir and thereafter, the container can be agitated to mix the contents of the first and second reservoirs thoroughly together. This arrangement is particularly advantageous, as it requires only a small and easy rotation of the lid to release the second reservoir from the storage position, whereafter the lid can be rotated the same amount in the return direction and the container can then be shaken for thorough mixing of the two products of the first and second reservoirs. Only once the two products have been thoroughly mixed together is it necessary for the lid to be rotated sufficiently to open the opening of the first reservoir so that the mixed products can be consumed through that opening.

In some arrangements, the second reservoir can be connected to the lid in the storage position and disconnection of the second reservoir from the lid for release of the second reservoir from the storage position occurs upon rotation of the lid in a direction to open the opening of the first reservoir. Preferably the connection between the lid and the second reservoir forms at least a portion of a sealing arrangement to seal the second reservoir against egress of product within it when the second reservoir is in the storage position.

The connection between the lid and the second reservoir can include a skirt or spigot which extends from the lid, preferably centrally thereof and which connects with the second reservoir. The spigot is preferably cylindrical and an end portion of the second reservoir is preferably arranged to engage within an internal surface of the spigot and preferably to be a friction fit against that surface.

While it is preferable that the spigot is cylindrical, it is to be noted that the spigot could be constructed as a series of discrete portions, such as a series of portions which are separated by a plurality of slits, but which otherwise form a part which can connect to the second reservoir. Thus, the reference to a spigot should include any form of connection which extends from the lid for connection to the second reservoir.

The connection between the lid and the second reservoir can additionally or alternatively include a projection, that extends into a groove which is shaped to snugly receive the projection. This arrangement can be formed on any suitable parts of the lid and the second reservoir, although in a preferred arrangement, the projection or groove is formed at or adjacent a free end of the spigot.

In some arrangements which employ a spigot of the kind discussed above, the free end of the spigot, remote from the attachment end of the spigot to the lid, extends into the second reservoir and the projection or groove discussed above, which is at or adjacent the free end of the spigot, engages a respective groove or projection formed in or on an internal surface portion of the second reservoir. By this arrangement, rotation of the lid in a direction to open the opening of the first reservoir causes relative movement between the spigot and the second reservoir to disengage the respective projection and groove and so release the second reservoir from the storage position.

In addition or alternative to the arrangements discussed above, the second reservoir can define a recess into which at least a portion of the spigot, preferably a free end of the spigot, can extend. That recess can include one of the projection or groove discussed above and the portion of the spigot that extends into the recess can include the other of the projection or groove. Thus, upon entry of the portion of the spigot into the recess, the projection will be received within the groove thus forming a connection between the second reservoir and the spigot. That connection can form or contribute to a sealing arrangement to seal the second reservoir against egress of product within it when the second reservoir is in the storage position.

In alternative arrangements, the first reservoir can include a threaded neck to which a threaded connector is applied and which has first and second threaded portions. The first portion can be attached to the neck while the lid can be attached to the second portion. In this arrangement, the first and second portions have threads which are formed in reverse directions so that when the lid is rotated on the second portion in a direction to open the opening of the first reservoir, the connector does not unthread from the neck. In some arrangements, the connector can form an abutment for cooperation with the second reservoir to prevent the second reservoir moving with the lid as the lid is rotated on the second threaded portion of the connection in a direction to open the opening of the first reservoir. By that arrangement, rotation of the lid in that direction to open the opening of the first reserve causes movement of the lid relative to the second reservoir, to release the second reservoir from the storage position.

In some embodiments, the first reservoir can have a threaded neck to which the lid is threadably connected and in these arrangements, it is preferable that the second reservoir at least partly extends into the neck in the storage position of the second reservoir. In these arrangements, a sleeve can be disposed between the neck and the portion of the second reservoir that extends into the neck and the sleeve can have one or more operations.

One first operation is that the sleeve can form a first abutment for abutting engagement with the second reservoir in the storage position, for preventing the second reservoir from moving in the direction of movement of the lid as the lid is rotated in a direction to open the opening of the first reservoir. By causing the lid to move relative to the second reservoir the second reservoir can be released from the storage position. The abutment can be formed by a projection that extends inwardly from the sleeve, such as by a lip that extends from an internal surface of the sleeve. A single lip can be provided, or a plurality of lips can be provided. In one arrangement, a single, cylindrical lip is provided. The second reservoir likewise can include an abutment for abutting with the sleeve abutment and that abutment can take any suitable form, such as a recess formed in the wall of the second reservoir, or a projection which extends from that wall. Other forms of abutments can be provided by both the sleeve and the second reservoir.

The sleeve can also form a second abutment for abutting engagement with the second reservoir in the storage position, the second abutment preferably being spaced from the first abutment longitudinally of the neck. This arrangement advantageously provides two points of abutment contact between the sleeve and the second reservoir, so providing for stable location of the second reservoir in the storage position. The two points of abutment contact can thus maintain the second reservoir correctly positioned despite the container being knocked or bumped during normal use. This means that the sealing arrangement which is formed to ensure that the contents of the second reservoir do not leak into the first reservoir, is less likely to fail due to knocks or bumps that the container might experience.

The second abutment can be formed at a free end of the sleeve, which is preferably that end which is inboard of the open end of the neck, and which abuts with a suitable abutment of the second reservoir.

The sleeve can alternatively or additionally extend over the free end of the neck to form a seal with an internal surface of the lid when the lid is in a position to close the opening of the first reservoir. The sleeve and lid can cooperate to seal through a projection and groove arrangement, or by any other suitable arrangement, such as by surface to surface pressure engagement.

Still further, the sleeve can additionally or alternatively function to prevent the second reservoir from egressing through the opening of the first reservoir when the second reservoir has been released from the storage position and the lid has been rotated to open the opening of the first reservoir in order that the contents of the first reservoir can be consumed through the first opening. In other words, the sleeve can be arranged to prevent the second reservoir from release from the container, while the product of the container is being swallowed. In this capacity, the sleeve acts as a safety device, to prevent the second reservoir from being swallowed and so to prevent a user from choking on the second reservoir.

Any of the above described sleeves can be formed to be removable, first for cleaning purposes, but in one form, so that second reservoir can be removed from the container for refilling. This advantageously allows the container to be reused and can allow a user of the container to change the product which is added to the second reservoir.

The present invention also extends to a method of mixing one product with another, wherein the method involves employing a container of the above described kind and firstly placing a first product in the first reservoir and a second product in the second reservoir. The second reservoir is then placed in the storage position and when it is desired to mix the respective products of the first and second reservoirs, the lid can be rotated in a direction to open the opening of the first reservoir to cause the second reservoir to be released and displaced from the storage position and to discharge the second product from the second reservoir and into the first reservoir. In some forms of this method, the lid can be then rotated in the reverse direction to close the opening of the first reservoir so that the container can be agitated to mix the contents of the first and second reservoirs thoroughly. Thereafter, the lid can be rotated to open the opening of the first reservoir and the mixed products can then be consumed through the opening of the first reservoir.

The attached drawings show an example embodiment of the invention of the foregoing kind. The particularity of those drawings and the associated description does not supersede the generality of the preceding broad description of the invention.

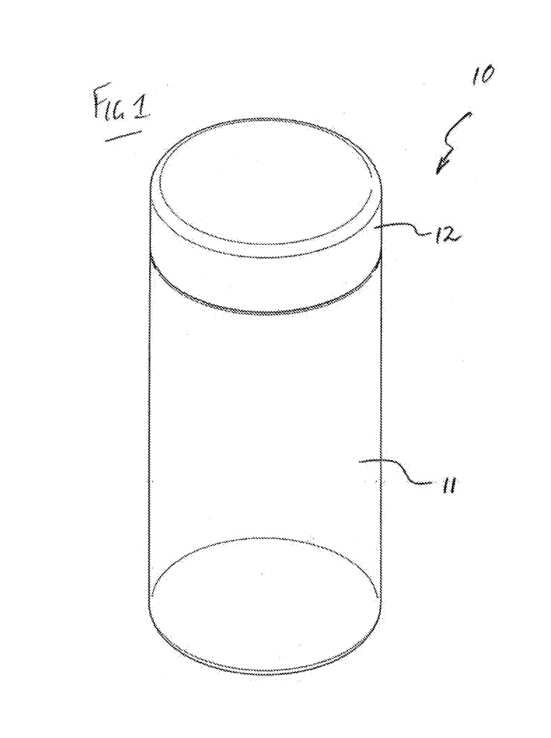

FIG. 1 is a perspective view of a container according to the invention.

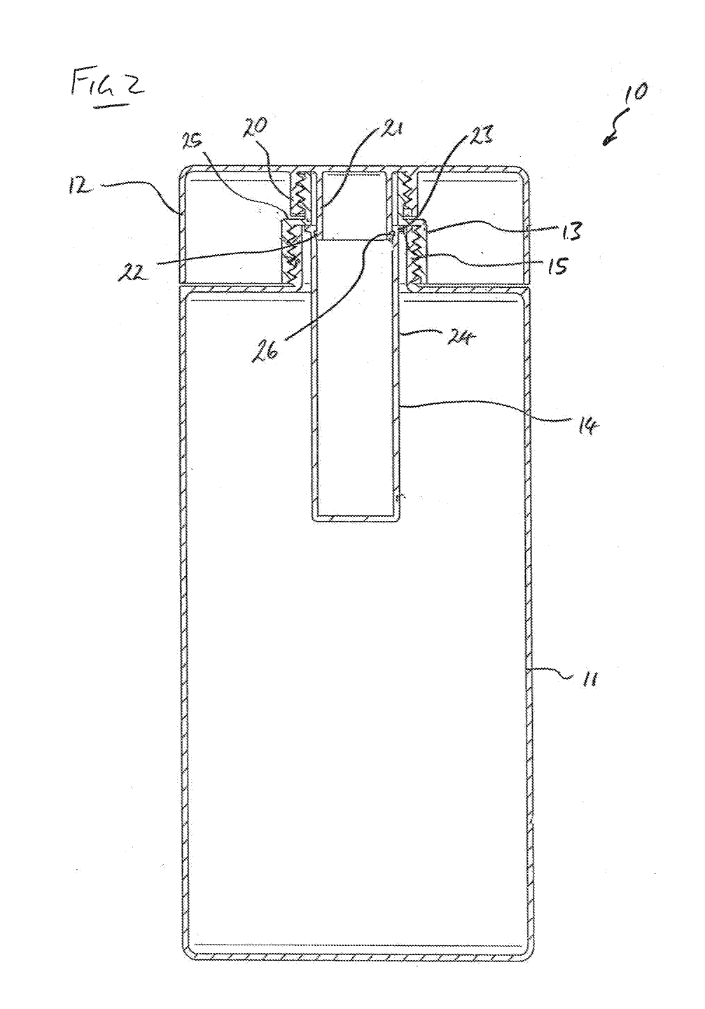

FIG. 2 is a cross sectional view of the container of FIG. 1.

FIG. 3 is a perspective exploded view of the container of FIG. 1.

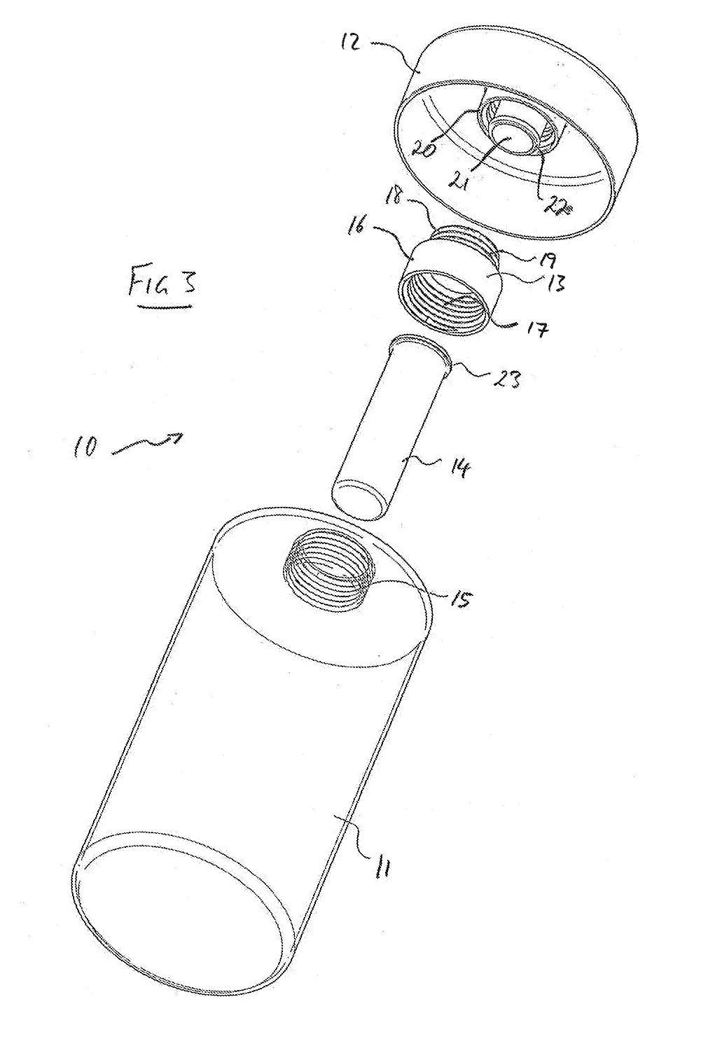

FIG. 4 is a part exploded, part assembled view of the container of FIG. 1.

FIG. 5 is a cross sectional view of one portion of the container of FIG. 1.

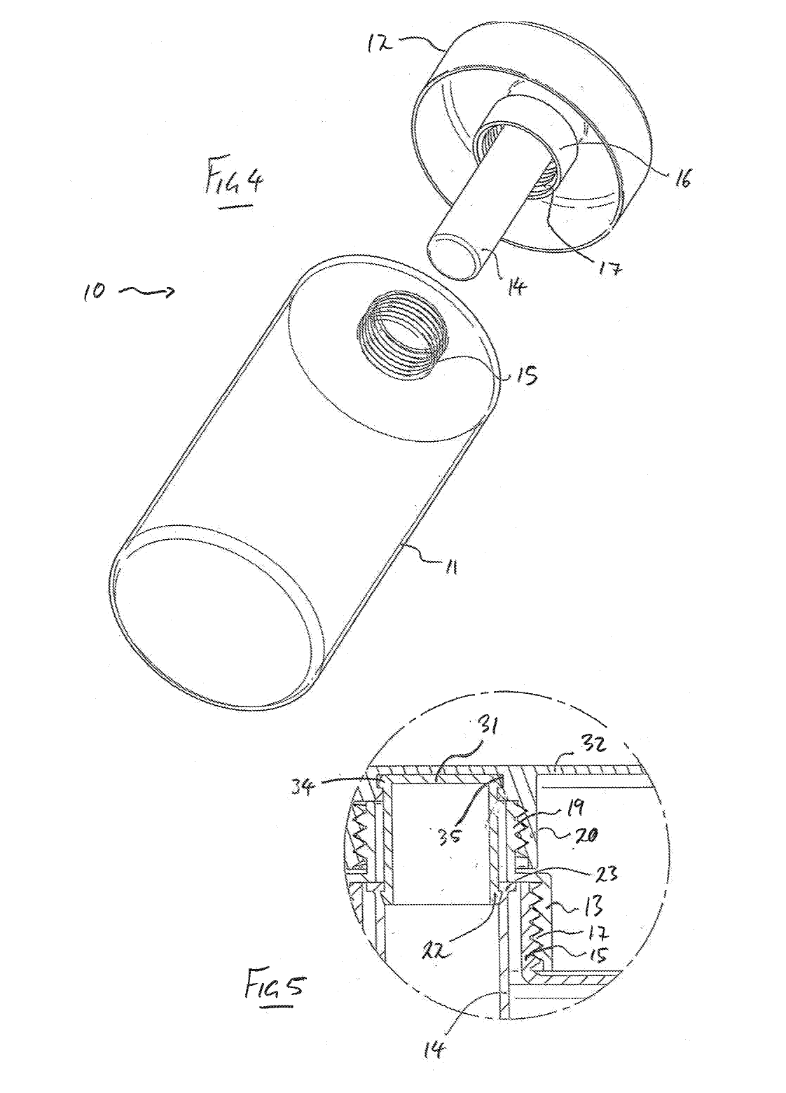

FIG. 6 is a cross sectional view of an alternative container according to the invention.

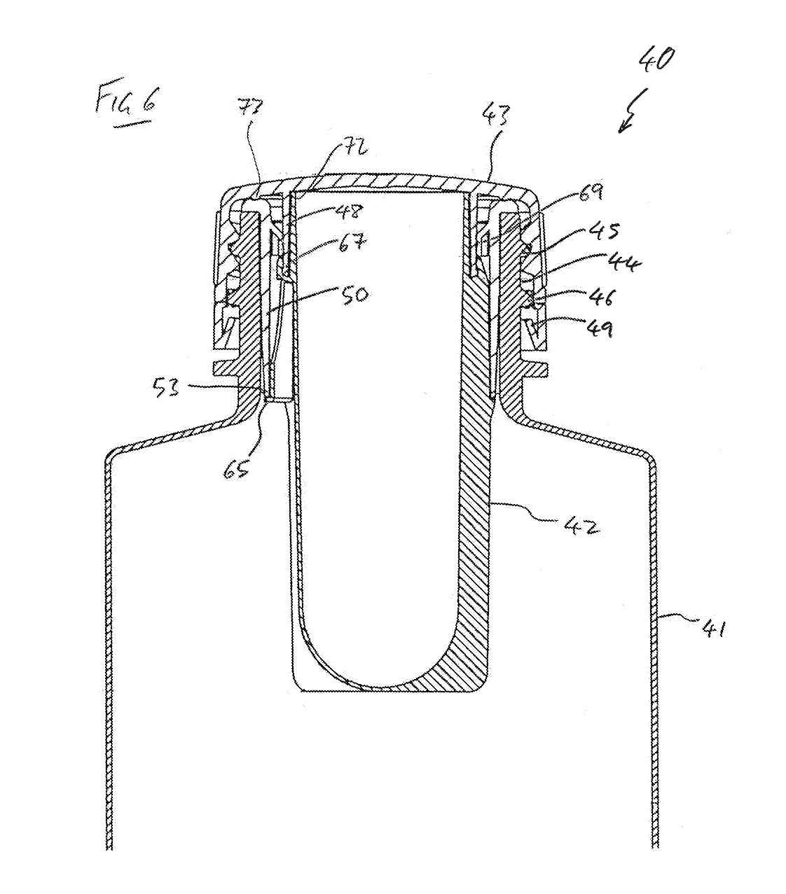

FIG. 7 is a cross sectional view of the lid of the container of FIG. 6.

FIG. 8 is a cross section view of a sleeve of the container of FIG. 6.

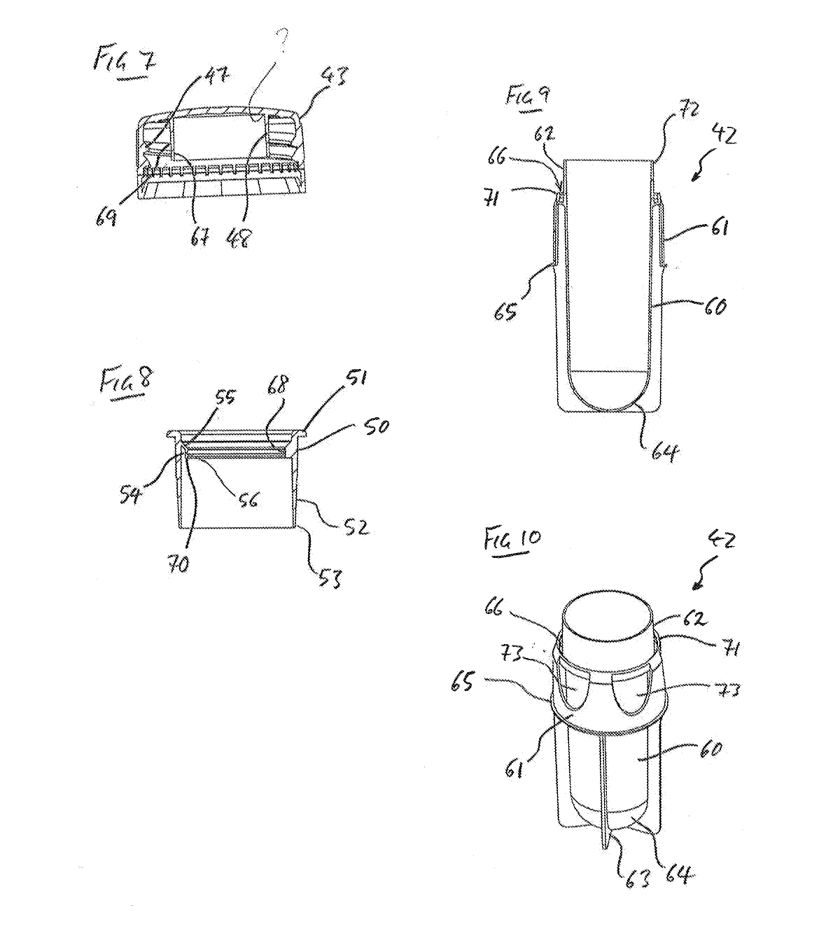

FIG. 9 is a cross section view of a second reservoir of the container of FIG. 6.

FIG. 10 is perspective view of the second reservoir of FIG. 9.

FIGS. 1 to 5 show a first embodiment of a liquid storage device 10. The device 10 has a liquid reservoir 11, a lid 12, a connector 13 and a substance reservoir 14.

As shown in FIG. 2, the lid 12 can be screwed onto, and unscrewed from, the connector 13 which itself can be screwed onto, and unscrewed from, a neck 15 which forms part of the liquid reservoir 11.

The connector 13 is best shown in FIG. 3. The connector 13 has a large diameter section 16 which has an internal thread 17, and a small diameter section 18 which has an external thread 19. The connector 13 is arranged to screw onto the neck 15 by threaded engagement with the internal thread 17, and to the lid 12 by threaded engagement with the external thread 19. The direction of the thread 17 is reverse or opposite to the direction of the thread 19, so that when the lid 12 is rotated in a direction to remove the lid from the connector 13, the connector 13 does not unscrew from the neck 15 together with the lid 12.

The lid 12 includes an internally threaded spigot 20, and a spigot connector 21. The threaded spigot 20 screws onto, and unscrews from, the connector 13. The spigot connector 21 is cylindrical and includes a radial flange 22 at its distal end. The flange 22 is arranged to engage with an open end of the substance reservoir 14, so that the substance reservoir 14 can be secured to the spigot connector 21.

The substance reservoir 14 is elongate and cylindrical and includes a radial flange 23. The flange 23 extends radially outwardly from the wall 24 of the substance reservoir 14 and is arranged to engage against a bridging portion 25 of the connector 13 which bridges between the portions 16 and 18 of the connector 13. That engagement prevents the substance reservoir 14 from egress through the portion 18 of the connector 13 when the lid 12 has been threadably disengaged from the connector 13.

The substance reservoir 14 further includes an inwardly opening groove 26 adjacent the flange 23 which receives the flange 22 of the spigot connector 21 for securing the substance reservoir 14 to the spigot connector 21. The spigot connector 21 and the substance reservoir 14 are a snap-fit.

The assembly and use of the device 10 will now be described with reference to FIGS. 3 and 4. For this description, the device 10 is assumed to be disassembled as shown in FIG. 3 and with the liquid reservoir 11 empty.

However, it should be appreciated that the device 10 can be pre-filled with a liquid, in which case, the device 10 can be partially assembled with the liquid reservoir 11, the connector 13 and the lid 12 assembled together. The device 10 is supplied separately with a substance reservoir 14 having a substance retained therein, or empty for later insertion of a substance.

With the above assumption in mind, the liquid reservoir 11 is empty and is filled with a liquid. The connector 13 is threadably connected to the spigot 20 of the lid 12 and thereafter, the substance reservoir 14 is connected to the lid 12 as shown in FIG. 4 by snap-fitting the flange 22 of the spigot connector 21 into the groove 26 of the substance reservoir 14. The connector 13 is then threadably connected to the neck 15 of the liquid reservoir 11. The device 10 is thus fully assembled as shown in FIG. 2.

When the user chooses to mix the contents in the liquid and substance reservoirs 11 and 14, the lid 12 is rotated relative to the portion 18 of the connector 13. Because the threads of the respective portions 16 and 18 of the connector 13 are reversed, the connector 13 will remain connected to the neck 15 of the liquid reservoir 11. The lid 12 therefore disengages from the connector 13. By that disengagement, the substance reservoir 14 is dislodged from connection with the spigot connector 21, because the substance reservoir 14 is prevented from moving with the lid 21 by the engagement between the flange 23 of the substance reservoir 14 and the bridging portion 25 of the connector 13. Once dislodged, the substance reservoir 14 is free to drop into the liquid reservoir 11. It will be appreciated that until this dislodgement occurs the interior of the substance reservoir 14 is quarantined from the interior of the liquid reservoir 11 by its connection to the lid 12.

The user can then screw the lid 12 back onto the connector 13 and can shake the device 10 to allow the substance within the substance reservoir 14 to egress and mix with the liquid within the liquid reservoir 11. This allows the user to consume a liquid that has been freshly mixed with a substance stored in the sealed environment of the substance reservoir 14.

A further embodiment is shown in FIG. 5, which is a partial cross-sectional view of a portion of a lid 32 for a liquid storage device of the kind illustrated in FIGS. 1 to 4. The lid 32 includes a spigot connector 31 which is formed separately from the lid 32 and which is attached to the lid 32 by a flange 34 which is received within a recess 35. This embodiment can provide for a more easily moulded lid 32 by the absence of the spigot connector 31. The spigot connector 31 can be snap fitted to the lid 32 when assembling the device 30.

In all other respects, the lid 32 operates in the same manner as the lid 12 of the liquid storage device 10 of FIGS. 1 to 4 and therefore for other parts shown in FIG. 5, the part numbers from the earlier figures are employed.

A third embodiment is shown in FIG. 6, in which an upper portion of a liquid storage device 40 is illustrated in cross-section. The bottom portion of the liquid storage device 40 is irrelevant to the present invention and is therefore not illustrated. The device 40 includes a liquid reservoir 41, a substance reservoir 42 and a lid 43.

The liquid reservoir 41 includes a neck 44 that has an outer thread 45 and a flange 46. The flange 46 is employed to cooperate with an inwardly inclined leg 49 of the bottom end of the lid 43 when the lid 43 is removed from the neck 44, to identify that the lid 43 has been removed and so to act as a tamper evidence indicator. A perforated strip is formed in the lid 43 adjacent the flange 46, whereby rotation of the lid 43 relative to the flange 46 causes the inclined leg 49 to engage the flange 46 and because the leg 49 cannot move past the flange 46, the perforations break and the bottom end of the lid 43 separates from the remainder of the lid 43, thus showing that the device 40 has been opened or tampered with.

The lid 43 is shown in cross-section in FIG. 7. This figure shows an internal thread 47 which cooperates with the thread 46 of the neck 44 and also shows an inboard spigot 48 which is circular and central of the lid 43.

Returning to FIG. 6, the device 40 further includes a sleeve 50 which fits into the neck 44 and which is disposed between the neck 44 and the substance reservoir 42 in the assembled condition. The sleeve 50 is shown in cross-section in FIG. 8 and from that figure, it can be seen that the sleeve 50 includes a flange 51 which depends from an upper end of the sleeve 50 and a cylindrical body 52 that tapers from the flange 51 to a bottom end 53. A lip 54 depends from the inside surface of the body 52 adjacent to the flange 51 and includes a first angled portion 55 and a second cylindrical portion 56. The operation of the lip 54 will be described later herein.

The substance reservoir 42 is shown in cross-section in FIG. 9 and in perspective view in FIG. 10, and includes a containment portion 60 within which a substance for later mixing with liquid in the liquid reservoir 41 can be contained. A skirt 61 is connected to the outer surface 62 of the containment portion 60.

The skirt 61 includes a bottom flange 65 which in the assembled condition of the device 40 shown in FIG. 6, abuts against the bottom end 53 of the sleeve 50. This abutment forms one of two abutments that locate the substance reservoir 42 in position relative to the lid 43 and the sleeve 50. The other abutment will be discussed later herein. Thus, in the assembled condition of the device 40 shown in FIG. 6, bottom end 53 of the sleeve 50 is shown in abutment with the flange 65.

The skirt 61 extends slightly upwardly in the orientation shown in FIG. 9, to create an upwardly opening recess 66 between the skirt 61 and the surface 62 of the containment portion 60, for receipt of the bottom end 67 of the spigot 48 of the lid 43. It can be seen from FIG. 7, that the bottom end 67 is shaped to define an outward flange or bulge, while the recess 66 has a profile at the inner end thereof for complementary receipt of the outward flange or bulge. The arrangement is such as to cause the substance reservoir 42 to be secured to the lid 43 by the cooperation between the spigot 48 and the recess 66. The cooperation is also such as to form part of a sealing arrangement of the device 40. Thus, the snug receipt of the bottom end 67 within the recess 66 is operable to form a seal against passage of liquid in either direction between the substance reservoir 42 and the liquid reservoir 41.

The lip 54 of the sleeve 50 also cooperates with the spigot 48 of the lid 43 at a position spaced from the bottom end 67 of the spigot 48. The lip 54 includes an inwardly opening groove 68 for receipt of an outwardly extending projection 69 formed on the spigot 48. The groove 68 is shown in FIG. 8, while the projection 69 is shown in FIG. 7. The projection 69 can be of a similar shape to the bottom end 67 of the spigot 48, with the groove 68 being of a shape to snugly receive the projection 69. The cooperation between the groove 68 and the projection 69 is provided as part of the overall sealing arrangement of the device 40. Thus, like the seal formed between the bottom end 67 and the recess 66, described above, the cooperation between the groove 68 and the projection 69 contributes to the sealing against passage of liquid in either direction between the substance reservoir 42 and the liquid reservoir 41.

In the assembled condition shown in FIG. 6, the bottom end 70 (see FIG. 8) of the lip 54 is in abutment with the opposing end 71 (see FIG. 10) of the skirt 61. The abutment forms another component of the sealing arrangement which seals against passage of liquid in either direction between the substance reservoir 42 and the liquid reservoir 41. The abutment also serves to locate the substance reservoir 42 properly within the liquid reservoir 41, while a second abutment, which is described later herein, assists that proper location.

A further seal is created by a frictional fit between the surface 62 of the second reservoir 42 and the upper inside surface of the spigot 48. The spigot 48 has a thicker wall thickness at its connection to the lid 43, so that the inside diameter of the spigot 48 at that point is reduced compared to the inside diameter further away or remote from the connection to the lid 43. Thus, as the second reservoir 42 pushes into the spigot 48, the upper end of the second reservoir 42 frictionally engages the inside surface of the spigot 48.

The seals thus provided in the device 40 include:

1 The abutment between the bottom end 70 and the opposing end 71.

2 The receipt of the bottom end 67 within the recess 66.

3 The receipt of the projection 69 within the groove 68.

4 The friction fit of the second reservoir 42 within the spigot 48.

These seals reliably prevent leakage in either direction between the first and second reservoirs 41 and 42. A further seal 73 will be described later herein in relation to prevention of leakage from the first reservoir 41 past the lid 43.

By these seals, the interior of the containment portion 60 of the substance reservoir 42 can be safely sealed against communication with the interior of the liquid reservoir 41 in the assembled condition shown in FIG. 6. This beneficially maintains the products in each of the reservoirs 41 and 42 separate until mixing of the products is required.

The abutment between the lip 54 and the end 71 of the skirt 61 forms the second of the two abutments referred to above. By the two abutments, the substance reservoir 42 can be securely held in the correct position despite the device 40 being subject to knocks or bumps. The two abutments effectively provide two points of contact that are spaced longitudinally apart and so resist movement of the substance reservoir 42. This secure location of the substance reservoir 42 assists the sealing arrangements described above to seal against leakage of substance from the substance reservoir 42.

The skirt 61 includes a plurality of openings 74 as shown in FIG. 10. These openings 74 reduce the amount of material of the skirt 61.

The liquid storage device 40 advantageously is reusable. Reuse is facilitated by the use of the sleeve 50 which is a friction fit within the neck 44. The sleeve 50 can thus be removed from the neck 44 of the liquid reservoir 41 when required. Prior to removal, the sleeve 50 prevents passage of the substance reservoir 42 through the neck 44 when liquid within the liquid reservoir 41 is passing through the neck 44, ie when the lid 43 has been removed and the mixed liquid is being consumed. The sleeve 50 prevents passage of the substance reservoir 42 through the neck 44 by the abutment between the bottom end 53 of the sleeve 50 and the flange 65 of the substance reservoir 42. However, to reuse the device 40, the sleeve 50 can be removed and that allows removal of the substance reservoir 42 through the neck 44 for refilling, because the internal diameter of the neck 44 is larger than the maximum external diameter of the substance reservoir 42. Once refilled, the sleeve 50 can be reinserted into the neck 44 in the assembly sequence described below.

It can be seen in FIG. 6 that the bottom end 53 of the sleeve 50 bends or flares slightly inwardly and away from the internal surface of the neck 44. This advantageously facilitates easier insertion of the sleeve 50 into the neck 44, by ensuring that the bottom end 53 of the sleeve 50 is of a smaller outside diameter than the inside diameter of the neck 44.

It can be seen that in the assembled condition of the device 40, a further seal 73 exists between the lid 43 and the sleeve 50. The seal 73 comprises a circular bead which projects from the lid 43 and a circular groove formed in the facing surface of the sleeve 50. The seal 73 prevents egress of liquid from the liquid reservoir 41 when the lid 43 is firmly fixed to the neck 44.

The actual sequence of assembly of the device 40, either for first use or for reuse, involves inserting a substance into the substance reservoir 42, then inserting the substance reservoir 42 into the sleeve 50 and then applying the lid 43 to the connected substance reservoir 42 and sleeve 50. That combination of parts is then assembled into the neck 44 of the liquid reservoir 41, which has been filled with a suitable liquid, by rotating the lid 43 onto the neck 44.

When mixing of the substance with the liquid is to take place, the lid 43 is rotated in a direction to remove the lid 43 from the neck 44. The lid 43 thus moves relative to the sleeve 50 and the substance reservoir 42, disconnecting the spigot 48 from the recess 66 and shifting the spigot 48 relative to the end portion 72 of the substance reservoir 42. When sufficient movement has taken place, the substance reservoir 42 will fall into the liquid reservoir 41 and the substance will egress for mixing with the liquid in the liquid reservoir 41. The device 40 can then be shaken if necessary to properly mix the substance and the liquid. Testing to date has revealed that the substance reservoir 42 can be dislodged with as little as a half turn of the lid 43.

The device 40 can be supplied with each of the liquid reservoir 41 and the substance reservoir 42 containing a liquid and a substance respectively. By the sealing arrangement discussed earlier between the substance reservoir 42, the lid 43 and the sleeve 50, the substance in the substance reservoir 42 can be sealed against transfer to the liquid in the liquid reservoir 41, until mixing is required.

The device 40 can also be reused as described above, or it can be supplied with each of the liquid and substance reservoirs 41 and 42 empty, so that the user can fill the respective reservoirs with his or her choice of liquids/substances at a suitable time and location.

The liquid storage devices 10 and 40 allow a person to conveniently mix a liquid with another substance just prior to consumption so as to preserve the freshness, and thus the efficacy, of the substance.

Although the invention has been described with reference to water and powdered vitamin supplements it will be appreciated by a person skilled in the art that the invention is not limited to this combination and is equally suitable for many other product combinations.

The invention described herein is susceptible to variations, modifications and/or additions other than those specifically described and it is to be understood that the invention includes all such variations, modifications and/or additions which fall within the spirit and scope of the above description.

1. A container including:
first and second reservoirs for containing products to be mixed, the first and second reservoirs each having an opening through which release of product contained in the respective reservoirs can egress, the opening of the first reservoir being closed by a threaded lid in a closed condition of the container,
the second reservoir having:
i—a storage position in which a product contained in the second reservoir is maintained separate from a product contained in the first reservoir, and
ii—a discharge position displaced from the storage position in which a product contained in the second reservoir is dischargeable through the second reservoir opening into the first reservoir for mixing with the product contained in the first reservoir,
wherein displacement of the second reservoir from the storage position to the discharge position requires rotation of the lid in a direction to open the opening of the first reservoir, that rotation facilitating release of the second reservoir from the storage position.

2. A container according to claim 1, wherein the amount of rotation of the lid to facilitate displacement of the second reservoir from the storage position to the discharge position is less than the amount of rotation required to open the opening of the first reservoir.

3. A container according to claim 1 or 2, wherein following rotation of the lid to release the second reservoir from the storage position, the second reservoir is displaced from the storage position to the discharge position by gravity.

4. A container according to any one of claims 1 to 3, wherein following release of the second reservoir from the storage position to the discharge position, the lid can be returned to close the opening of the first reservoir so that the container can be agitated to mix the contents of the first reservoir and the second reservoir together.

5. A container according to any one of claims 1 to 4, wherein in the storage position, the second reservoir is connected to the lid and disconnection of the second reservoir from the lid occurs upon rotation of the lid in a direction to open the opening of the first reservoir.

6. A container according to claim 5, wherein the connection between the lid and the second reservoir forms at least a portion of a sealing arrangement to seal the second reservoir against egress of product within the second reservoir when the second reservoir is in the storage position.

7. A container according to claim 5 or 6, wherein the connection between the lid and the second reservoir includes a spigot which extends from the lid and connects with the second reservoir.

8. A container according to claim 7, wherein an end portion of the second reservoir engages an internal surface of the spigot and is a friction fit within the spigot.

9. A container according to any one of claims 5 to 8, wherein the connection between the lid and the second reservoir includes a projection that extends into a groove which is shaped to snugly receive the projection.

10. A container according to claim 9, wherein one of the projection or groove is formed at or adjacent a free end of the spigot.

11. A container according to claim 10, wherein the free end of the spigot extends into the second reservoir and the projection or groove at or adjacent the free end engages a respective groove or projection formed in or on an internal surface portion of the second reservoir and whereby rotation of the lid in a direction to open the opening of the first reservoir causes relative movement between the spigot and the second reservoir to disengage the respective projection and groove so as to release of the second reservoir from the storage position.

12. A container according to any one of claims 7 to 11, wherein the second reservoir defines a recess into which at least a portion of the spigot extends.

13. A container according to any one of claims 1 to 11, wherein the first reservoir has a threaded neck to which a threaded connector is applied, the connector including first and second threaded portions, the first portion being attached to the neck and the lid being attached to the second portion, the first and second threaded portions having threads formed in reverse directions, so that when the lid is rotated on the second portion in a direction to open the opening of the first reservoir, the connector does not unthread from the neck.

14. A container according to claim 13, wherein the connector forms an abutment for cooperation with the second reservoir to prevent the second reservoir moving with the lid as the lid is rotated on the second threaded portion to open the opening of the first reservoir.

15. A container according to any one of claims 1 to 12, wherein the first reservoir has a threaded neck to which the lid is threadably connected, and at least a portion of the second reservoir extends into the neck in the storage position of the second reservoir.

16. A container according to claim 15, wherein a sleeve is disposed between the neck and the portion of the second reservoir that extends into the neck, the sleeve forming a first abutment for abutting engagement with the second reservoir in the storage position for preventing the second reservoir from moving in the direction of movement of the lid as the lid is rotated in a direction to open the opening of the first reservoir, so as to facilitate release of the second reservoir from the storage position.

17. A container according to claim 16, wherein the abutment is formed by a projection that extends inwardly from the sleeve.

18. A container according to claim 17, wherein the projection is formed by lip that extends from an internal surface of the sleeve.

19. A container according to any one of claims 16 to 18, wherein the sleeve forms a second abutment for abutting engagement with the second reservoir in the storage position, the second abutment being spaced from the first abutment longitudinally of the neck.

20. A container according to any one of claims 16 to 20, wherein the sleeve extends over the free end of the neck and forms a seal with the lid when the container in the closed condition.

21. A container according to claim 15, wherein a sleeve is disposed between the neck and the portion of the second reservoir that extends into the neck, the sleeve preventing the second reservoir from egressing through the opening of the first reservoir when the second reservoir has been released from the storage position and the lid has been rotated to open the opening of the first reservoir for egress of the product contained in the first reservoir through the opening of the first reservoir.

22. A container according to claim 21, wherein the sleeve is removable to allow the second reservoir to be removed from the container.

23. A method of mixing one product with another product, the method employing a container according to any one of the preceding claims, the method including placing a first product in the first reservoir and a second product in the second reservoir, placing the second reservoir in the storage position, rotating the lid in a direction to open the opening of the first reservoir to cause the second reservoir to be released and displaced from the storage position and to discharge the second product into the second reservoir.

24. A method according to claim 23, wherein the container is agitated following release and displacement of the second reservoir from the storage position to mix the contents of the first reservoir and the second reservoir together.
